(19) United States
(12) Patent Application Publication
(10) Pub. No.: US 2017/0146987 A1
(43) Pub. Date: May 25, 2017

(54) ELECTRONIC CONTROL MODULE TESTING SYSTEM

(71) Applicant: Caterpillar Inc., Peoria, IL (US)

(72) Inventors: Naresh Ramakrishnan, Chennai (IN); Raghu C. Sankarayogi, Dunlap, IL (US)

(73) Assignee: Caterpillar Inc., Peoria, IL (US)

(21) Appl. No.: 14/946,775

(22) Filed: Nov. 20, 2015

(51) Int. Cl. G05B 23/02; G06F 17/50

(52) U.S. Cl. CPC G05B 23/0213; G06F 17/5009

(57) ABSTRACT

A testing system for testing an Electronic Control Module (ECM) of a machine is provided. The testing system comprises a host system and a hardware-in-loop (HIL) system. The HIL system includes a simulation model having one or more latency-sensitive test cases associated with the machine. The HIL system includes a processing unit. The processing unit is configured to simulate the one or more latency-sensitive test cases in response to a test initiation trigger signal from the host system. The testing system further includes an input/output (I/O) unit. The input/output unit is configured to communicate with the processor and an ECM under test.

### TECHNICAL FIELD

The present disclosure relates to testing system for an Electronic Control Module (ECM). More specifically, the present disclosure relates to the testing of the ECM using Hardware-in-the-loop (HIL) simulation.

### BACKGROUND

Hardware-in-the-loop (HIL) simulation based testing of the Electronic Control Modules (ECMs) is widespread. A testing system typically includes a Hardware-in-the-loop (HIL) system, a host system, and the ECM that to be tested. The HIL system includes a simulation model of a machine and/or an engine system of the machine. The simulation model is a user programmable environment which includes mathematical representations of the various dynamic processes related of the machine or the engine system. The HIL system may further include a processor and an Input/output (I/O) module. The processor is configured to execute a set of instructions, based on the simulation model, to output electric signals to the ECM via the I/O module. The host system is used to communicate with a user while providing inputs to the HIL system and receiving output from the HIL system as well as from the ECM.

The simulation model in the HIL system is programmable using a desktop automation application on the host system. The desktop automation application is also configure to send, receive and analyze the output from the ECM and HIL system. A communication channel, such as Controller Area Network (CAN), is used to send ECM output signals to the host system which can be monitored and compared with the output from the HIL system using the desktop automation application. While the desktop automation application improves the quality and efficiency of the testing system, an execution rate of the desktop automation application may pose a limitation on the certain test cases where the output is processed within a fraction of time from the input. Thus the current desktop automation tends to skip these test cases.

U.S. Pat. No. 8,204,711, hereinafter referred to as the '711 patent, provides a methods and apparatus for managing test procedures for a hardware-in-the-loop (HIL) simulation environment. The apparatus comprises an input interface for receiving input from a user, a first processor coupled to the input interface and in operable communication with the HIL simulation environment. The first processor is configured to generate a test sequence comprising a plurality of test procedure references based on input from the user. Each of the test procedure reference corresponds to a test procedure. The test procedure comprises instructions for issuing commands to, and receiving data from, the HIL simulation environment, and sequentially executes each referenced test procedure within the generated test sequence in cooperation with the HIL simulation environment, in response to a command from the user. However, the '711 patent does not provide real time test results as the test sequence stored in the host electronic device.

### SUMMARY OF THE DISCLOSURE

In one aspect of the present disclosure, a testing system for testing an Electronic Control Module (ECM) of a machine is provided. The testing system comprises a host system and a hardware-in-loop (HIL) system. The HIL system includes a simulation model having one or more latency-sensitive test cases associated with the machine. The HIL system includes a processing unit. The processing unit is configured to simulate the one or more latency-sensitive test cases in response to a test initiation trigger signal from the host system. The testing system further includes an input/output (I/O) unit. The input/output unit is configured to communicate with the processor and an ECM under test.

In another aspect of the present disclosure, hardware-in-loop (HIL) system for testing an Electronic Control Module (ECM) of a machine is provided. The HIL testing system includes a simulation model. The simulation model includes one or more latency-sensitive test case associated with the machine. The HIL testing system a processing unit. The processing unit is configured to simulate the latency-sensitive test case in response to a test initiation trigger signal. The HIL testing system also includes an input/output (I/O) unit. The I/O unit is configured to communicate with the processor and an ECM under test.

In yet another aspect of the present disclosure a method of hardware-in-loop (HIL) testing an Electronic Control Module (ECM) of a machine is provided. The method includes receiving a test initiation trigger signal from a host system. The method further includes processing one or more latency-sensitive test cases based on the received test initiation trigger signal. The method further includes outputting one or more test results corresponding to the one or more latency-sensitive test case from the ECM to the host system in real time.

Other features and aspects of this disclosure will be apparent from the following description and the accompanying drawings.

### BRIEF DESCRIPTION OF THE DRAWINGS

FIG. 1 is block diagram of a test environment for testing an Electronic Control Module (ECM) of a machine, according to one embodiment of present invention;

FIG. 2 is block diagram of an Electronic Control Module (ECM) of the machine;

FIG. 3 is a block diagram of a Hardware In Loop (HIL) system, according to one embodiment of present invention; and

FIG. 4 is a flow chart of a method of hardware-in-loop (HIL) testing an Electronic Control Module (ECM) of the machine, according to one embodiment of present invention.

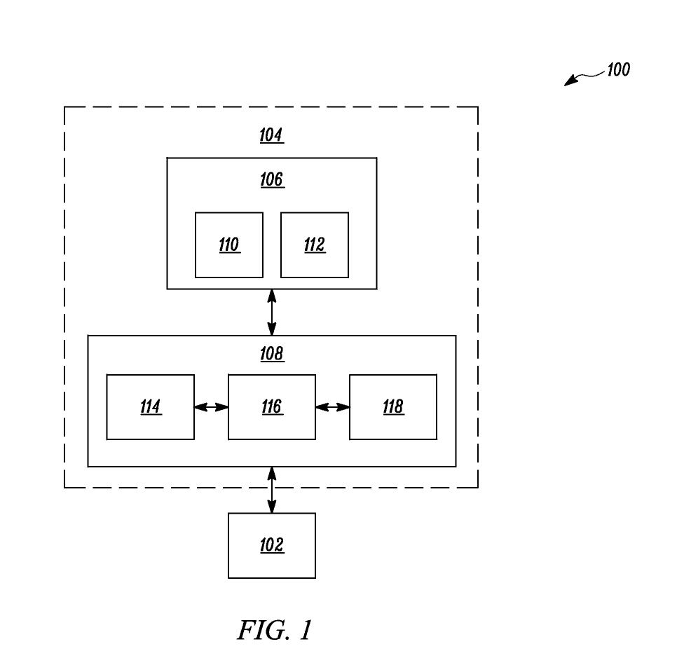

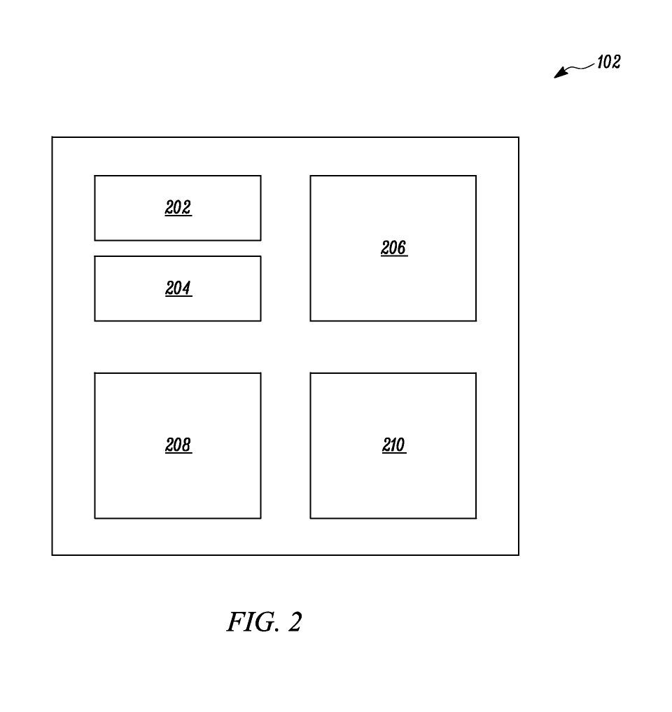

### DETAILED DESCRIPTION

Wherever possible, the same reference numbers will be used throughout the drawings to refer to the same or the like parts. FIG. 1 is block diagram of a test environment 100 for testing an Electronic Control Module (ECM) 102 for a machine. The test environment 100 includes the ECM 102 to be tested. The ECM 102 is an embedded system adapted to provide real time regulation for the machine in which it is to be used. The ECM 102 may be used in machines such as, but not limited to electrical machines, automobiles and the likes. The ECM 102 may be tested within a simulated environment generated by the test environment 100. The simulated environment corresponds to a real time environment generated by the machine in which the ECM 102 is used during an operation. In an exemplary embodiment, the ECM 102 may be a controlling unit for an automobile for controlling various components of the automobile such as, but not limited to, an engine, a transmission unit, a brake unit, a suspension unit, an exhaust unit, a steering unit, and the like. It may be contemplated that the machine may also include multiple ECMs for controlling each components of the machine. An exemplary block diagram of the ECM is given in FIG. 2.

Referring to FIG. 2, the ECM 102 includes a regulated power supply 202 for providing power supply to the ECM 102. The ECM 102 further includes a system clock 204. The system clock 204 may generate clock signal at a regular interval of time for triggering the ECM 102. In one example, the system clock 204 may be an oscillator. The ECM 102 also includes a memory unit 206 for storing multiple instructions. The memory unit 206 also stores data associated with the machine in which the ECM 102 is expected to be disposed. The memory unit 206 of the ECM 102 may include of read only memory (ROM), a random access memory (RAM), electrically erasable and programmable memory (EEPROM) and non-volatile RAM (NVRAM).

The ECM 102 also includes an input and output interface (I/O interface) 208. The input and output interface 208 of the ECM 102 is adapted to be connected to one or more sensors (not shown) and one or more actuators (not shown) of the machine. The ECM 102 also includes a central processing unit (CPU) 210. The CPU 210 of the ECM 102 may be a micro controller or micro processor. The CPU 210 generates multiple control signals to control the various component of the machine. The CPU implements a control algorithm to generate the control signals.

During operation of the machine, the sensors sense and indicate values of multiple operating parameter of the machine on which the sensor is implemented. The sensor also indicates desired values of the corresponding operating parameters. The values provided by the sensor may act as an input of the ECM 102. Based on the values, the CPU 210 of the ECM 102 generates the control signals. The control signals may be electrical signal. The actuator connected to the I/O interface 208 of the ECM 102 converts the control signal to a mechanical parameter for controlling the corresponding machine component.

Although, only the regulated power supply 202, the system clock 204, the memory unit 206, the I/O interface 208, and the CPU 210, are described with reference to the ECM 102, the ECM 102 may include any number of other modules, based on type of applications. It may be understood that the memory unit 206 and the CPU 210 disclosed herein in the context of the present disclosure may be distinct from each other with respect to architecture, data storage capabilities, type of data stored therein, data formats, and have distinct system implementation and functionality.

The test environment 100 of FIG. 1 includes a testing system 104. The testing system 104 is communicably connected the ECM 102. The testing system 104 tests various features of the ECM 102 such as, but not limited to, functioning of the ECM 102, system integration of the ECM 102, communication of the ECM 102 with various components of the machine and the like. In order to test aforementioned features of the ECM 102, the testing system 104 is enabled to generate the simulated environment of the machine in which the ECM 102 is expected to be implemented in real time. The simulated environment may include generating multiple electrical signals. Each of the electrical signals may be analogous the operational parameters measured by the sensor implemented at each of components of the machine during the real time operation.

The testing system 104 includes a host system 106. The host system 106 may be any microprocessor based system, for example, a computer or other processors configured to execute the functions that will be described herein. The host system 106 may include one or more modules for executing respective instructions and providing the output. In an example, the host system 106 includes a display module 112. The display module 112 may be any of the conventional display modules known in the art. The host system 106 further includes a desktop automation model 110. The desktop automation model 110 may be developed using any of a development platform known in the art, such as Python.

The desktop automation model 110 is enabled to render a graphical user interface (GUI) on the display module 112. The GUI enables a user interaction with the testing system 104. The GUI may include multiple graphical control elements that may allow the user to provide inputs related to various functions such as, but not limited to, select one or more features, create one or more files, view, provide one or more inputs and the like. In one example, the GUI is enabled to receive an input from the user for creating the simulated environment. The user input may be equivalent to a real time operating condition of the machine in which the ECM 102 is expected to implement. For instance, the input may be a speed time value of an automobile, if the machine is the automobile. The desktop automation model 110 is adapted to receive the input provided by the user from the GUI and generate a test initiation trigger signal corresponding to the user input.

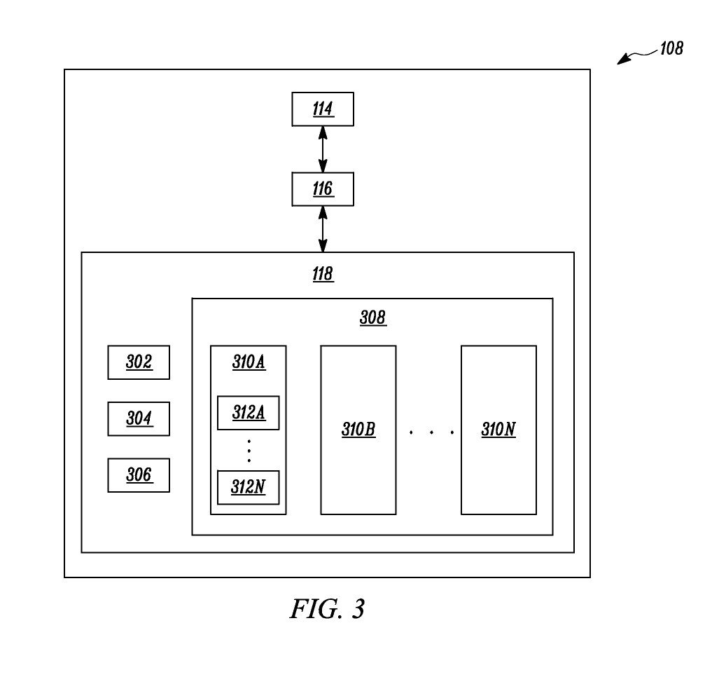

The testing system 104 includes a hardware in loop (HIL) system 108. The HIL system 108 is adapted to communicate with the host system 106. In addition The HIL system 108 is adapted to communicate with the ECM 102. The HIL system 108 receives the test initiation signal generated by the desktop automation model 110. Further, the HIL system 108 processes the test initiation signal to generate the simulated environment for the ECM 102. The HIL system 108 communicates the simulated environment with the ECM 102. The ECM 102 generates control signals corresponding to the simulated environment. The HIL system 108 retrieves the control signals generated at the ECM 102 and forms one or more test results. The HIL system 108 includes an input/output (I/O) unit 114, a processing unit 116 and a memory 118. The details of the HIL system 108 are illustrated in FIG. 3.

Referring to FIG. 3, a block diagram of the HIL system 108 is illustrated. The I/O unit 114 of the HIL system 108 is adapted to communicate with the host system 106 and the ECM 102. The I/O unit 114 of the HIL system 108 is adapted to communicate with the host system 106. In an embodiment, the I/O unit is connected to the processing unit 116 of the HIL system 108, such that the host system 106 can send instruction to the processing unit 116 and the processing unit 116 sends corresponding signals to I/O unit 114 via a peripheral high-speed (PHS) bus. The processing unit 116 of the HIL system 108 is connected to the host system 106 and the ECM 102 via at least one of an Industry standard architecture (ISA) bus, Personal Computer Memory Card International Association (PCMCIA) and Peripheral Component Interconnect (PCI). The I/O unit 114 is further adapted to condition and measure multiple signals generated at the ECM 102 during the testing. For example, if the machine is an automobile, then the I/O unit 114 is adapted to particularly measure the dynamics of vehicle and engine operations.

In one example, the I/O unit 114 may have an input port (not shown) and an output port (not shown). The input port may be communicated with the desktop automation model 110 of the host system 106 and the I/O interface 208 of the ECM 102. In an embodiment, the input for the HIL system 108 may be the test initiation trigger signal and the control signals generated at the ECM 102. The output ports of the I/O unit 114 may be communicated with the display module 112 of the host system 106. The output from the HIL system 108 may be the test results derived from the control signals.

The processing unit 116 of the HIL system 108 may include single processor or multiprocessor system. The processors of the processing unit 116 may be any general purpose processor or specific processor to operate in response to instruction. The processing unit 116 is connected to the I/O unit 114 and the memory 118 via any of the high speed buses known in the art. In response to the test initiation trigger signal received from the host system 106, the processing unit 116 is adapted to execute multiple instructions stored in the memory 118 of the HIL system 108. Further, the processing unit 116 is adapted to receive multiple instructions for generating the simulated environment of the machine in which the ECM 102 under test is implemented in real time.

The instructions and data associated with the host system 106, the ECM 102 and the HIL system 108 are stored in the memory 118. The memory 118 includes multiple modules such as, but not limited to, a test identification module 302, a simulator module 304 and a test result generation module 306. Each of the modules constitutes multiple instructions for performing various functions.

The memory 118 further includes one or more simulation models of associated with the machine and/or multiple components of the machine. For illustrative purpose, a simulation model 308 is shown in FIG. 3. The simulation model 308 includes multiple latency-sensitive test cases 310A, 310B, 310C . . . 310N (collectively referred as the latency-sensitive test case 310). The latency-sensitive test case 310 is hereinafter interchangeably referred to as test cases 310. Each of the test case 310 may have multiple test condition 312A, 312B . . . 312N (collectively referred as the test conditions 312) associated with the operation of the machine. The test condition 312 may be pre-determined operating condition of various components of the machine involved in the test case 310. The predetermined operating conditions are defined based on multiple signals from multiple sensors connected to the machine. The simulation model 308 is a user programmable environment which includes mathematical representations of the various dynamic processes related of the machine or the various components of the machine.

The test identification module 302 is configured identify the simulation model 308 corresponding to the ECM 102 under test based on the test initiation trigger signal. The test initiation trigger signal includes information in respect of simulation model 308, test cases 310 to be selected to generate the simulated environment corresponding to a functionality of the ECM 102 to be tested.

The simulator module 304 is adapted to execute the test conditions 312 associated with the test case 310. In real time, real sensors sense various parameters for the machine such as, but not limited to velocity, fuel level, fuel flow, temperature, torque etc. The sensor converts the sensed parameters to multiple electrical signals which may be readable to the ECM 102. In the test environment 100, the simulator module 304 is adapted to generate multiple electrical signals corresponding to the electrical signals of the real sensors. The generated signals are transferred to the ECM 102 under test. The ECM 102 generates multiple control signals as outputs corresponding to the electrical signals. The I/O unit 114 of the HIL system 108 receives the control signals generated at the ECM 102. The test result generation module 306 analyses the received control signal. Further, the test result generation module 306 forms one or more test results corresponds the received control signal. The one or more test results are communicated to the host system 106 via the I/O unit 114 of the HIL system 108. The host system 106 displays the test result on the display module 112 using the desktop automation model 110.

It may be contemplated that the test identification module 302, the simulator module 304 and the test result generation module 306 described herein are exemplary. The functionalities performed by each of the test identification module 302, the simulator module 304 and the test result generation module 306 may be performed in combination without any limitation. Further, additional functionalities may be performed by any of the test identification module 302, the simulator module 304 and the test result generation module 306.

Modules such as, but not limited to, a signal conditioning, multiple loads, a Failure Insertion Units (FIU) and a power supply are few conventional units present in the HIL system 108 for enabling real time testing of the ECM 102. In addition, an additional I/O, signal conditioning, fault simulation, and current measurement can be added to the HIL system 108 based on the requirement of testing of the ECM 102.

It is to be understood that individual features shown or described for one embodiment of the present disclosure may be combined with individual features shown or described for another embodiment of the present disclosure. The above described implementation does not in any way limit the scope of the present disclosure. Therefore, it is to be understood that although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The test environment 100 of present disclosure enables testing of the ECM 102 with high speed. In accordance with an embodiment of the present disclosure, the test cases 310 and the respective test conditions 312 are stored in the memory 118 of the HIL system 108, and thereby the involvement of the host system 106 to run the tests is not required. This reduces execution time of instruction considerably by increasing execution rate. The host system 106 is used to initiate the test cases 310 and to compare the test results. The testing system 104 according to present disclosure executes the test conditions 312 of each of the test cases 310 within negligible time delay. This provides a real time simulated environment to the ECM 102. The simulation model 308 includes test cases 310 having response time as few microseconds and/or milliseconds which might be skipped by the desktop automation model 110 or conventional test environment due to limitations in execution rate. For such crucial scenarios, the HIL system 108 of present disclosure is enabled to store such test cases 310. Hence, those test cases 310 are executed by the processing unit 116 of the HIL system 108 instead of host system 106.

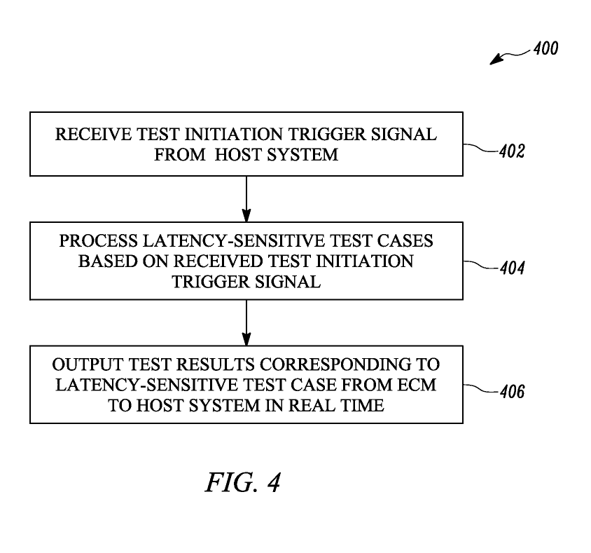

FIG. 4 is a flow chart of a method 400 of hardware-in-loop (HIL) testing an Electronic Control Module (ECM) 102 of a machine, according to one embodiment of present disclosure. At step 402, the method includes receiving the test initiation trigger signal from the host system 106. The desktop automation model 110 of the host system 106 provides the GUI corresponding to the test environment 100. The user is enabled to provide a user input to start the test of the ECM 102 via the GUI. The desktop automation model 110 generates the test initiation trigger signal using the user input.

At step 404, the method 400 includes processing one or more latency-sensitive test cases 310 based on the received test initiation trigger signal. The test cases 310 are defined in the simulation model 308. As noted in FIG. 3, the simulation model 308 includes one or more test conditions 312 corresponding to each of the latency-sensitive test case 310. The processing of test case 310 includes identifying the one or more latency-sensitive test cases corresponding to the test initiation trigger signal by the test identification module 302. The simulator module 304 simulates the test conditions corresponding to the identified test cases 310. Further, the ECM 102 is exposed to the simulated environment. The ECM 102 generates the control signal in response to the simulated environment.

At step 406, the method 400 includes outputting one or more test results corresponding to the one or more latency-sensitive test case from the ECM 102 to the host system 106 in real time. The control signals generated at the ECM 102 is retrieved by the I/O unit 114 of the HIL system 108. Further, the test results are formed from the control signals by the test result generation module 306. The test results are displayed on the display module 112 of the host system 106.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A testing system for testing an Electronic Control Module (ECM) for a machine, the testing system comprising:
a host system; and
a hardware-in-loop (HIL) system, the HIL system including:
a simulation model having one or more latency-sensitive test cases associated with the machine;
a processing unit configured to simulate the one or more latency-sensitive test cases in response to a test initiation trigger signal from the host system; and
an input/output (I/O) unit configured to communicate with the processing unit and an ECM under test.

2. The testing system of claim 1, wherein the host system including a display module.

3. The testing system of claim 1, wherein the host system including a desktop automation application.

4. The testing system of claim 3, wherein the desktop automation model configured to send the test initiation trigger signal corresponding to a user input.

5. The testing system of claim 1, wherein the I/O unit of the HIL system configured to communicate with a host system via the processing unit of the HIL system.

6. The testing system of claim 1, wherein each of the latency-sensitive test cases have one or more test conditions.

7. The testing system of claim 6, wherein the hardware-in-loop (HIL) system further including:
a test identification module for identifying the one or more latency-sensitive test cases corresponding to the test initiation trigger signal;
a simulator module for simulating one or more test conditions corresponding to the identified one or more latency-sensitive test cases; and
a test result generation module for generating one or more test results generating corresponding to one or more control signal retrieved from the ECM.

8. The testing system of claim 7, wherein the ECM generates one or more control signals corresponding to the simulation of the one or more latency-sensitive test case.

9. The testing system of claim 8, wherein the ECM is communicably connected to the HIL system to transfer one or more control signals generated while simulating the one or more latency-sensitive test case.

10. A hardware-in-loop (HIL) system for testing an Electronic Control Module (ECM) of a machine, the HIL testing system comprising:
a simulation model having one or more latency-sensitive test case associated with the machine;
a processing unit configured to simulate the latency-sensitive test case in response to a test initiation trigger signal; and
an input/output (I/O) unit configured to communicate with the processor and an ECM under test.

11. The HIL system of claim 10, wherein the test initiation trigger signal is given by a host system.

12. The HIL system of claim 10, wherein the I/O unit configured to communicate with a host system via the processing unit of the HIL system.

13. The HIL system of claim 10, wherein each of the latency-sensitive test cases have one or more test conditions.

14. The HIL system of claim 13 comprising:
a test identification module for identifying the one or more latency-sensitive test cases corresponding to the test initiation;
a simulator module for simulating one or more test conditions corresponding to the identified one or more latency-sensitive test cases; and
a test result generation module for generating one or more test results generating corresponding to the one or more control signal retrieved from the ECM.

15. A method of hardware-in-loop (HIL) testing an Electronic Control Module (ECM) of a machine, the method comprising:
receiving a test initiation trigger signal from a host system;
processing one or more latency-sensitive test cases based on the received test initiation trigger signal; and
outputting one or more test results corresponding to the one or more latency-sensitive test case from the ECM to the host system in real time.

16. The method of claim 15, wherein the test initiation trigger signal is associated with one or more user inputs.

17. The method of claim 15, further comprising:
providing the one or more latency-sensitive test case associated with the machine in a simulation model; and
defining one or more test conditions corresponding to each of the latency-sensitive test case.

18. The method of claim 17, wherein processing the one or more latency-sensitive test cases further comprises:
identifying the one or more latency-sensitive test cases corresponding to the test initiation; and
simulating the one or more test conditions corresponding to the identified one or more latency-sensitive test cases.

19. The method of claim 18, wherein outputting the one or more test results further comprises:
retrieving one or more control signal generated at the ECM associated with the one or more test conditions;
generating one or more test results corresponding to the one or more control signal retrieved from the ECM; and
displaying the retrieved one or more test results in a user interface of the host system.
